(19) United States
(12) Patent Application Publication
(10) Pub. No.: US 2023/0255178 A1
(43) Pub. Date: Aug. 17, 2023

(54) ANIMAL FEEDER SYSTEM

(71) Applicant: Daylight Wildlife Feeder LLC, Albany, OH (US)

(72) Inventors: Joseph Niese, Leipsic, OH (US); David Niese, Albany, OH (US)

(21) Appl. No.: 18/167,588

(22) Filed: Feb. 10, 2023

Related U.S. Application Data
(60) Provisional application No. 63/309,588, filed on Feb. 13, 2022.

(51) Int. Cl. A01K 5/02

(52) U.S. Cl. CPC A01K 5/0291

(57) ABSTRACT

An animal feeder system includes a container having a hollow interior configured to receive a product therein. The container includes a selectively positionable closure member configured to control access to the product. An actuator assembly is coupled to the closure member. The closure member is in the open first position when a first daylight period occurs, and/or when an illuminance level of a surrounding environment is at least a predetermined illuminance threshold value, and/or during a first time period. The closure member is in the closed second position during precipitation, and/or when a second daylight period occurs, and/or when the illuminance level of the surrounding environment is less than the predetermined illuminance threshold value.

### CROSS-REFERENCE TO RELATED APPLICATION

This application claims the benefit of U.S. Provisional Pat. Application No. 63/308,588, filed on Feb. 10, 2022, which is hereby incorporated in its entirety.

### FIELD

The presently disclosed subject matter relates to an animal feeder, and more particularly to an automatic animal feeder system.

### BACKGROUND

Natural stimuli for animal (e.g. wild game) activity include hunger, curiosity, mating, etc. Responses of such animals are to travel to a food source, seek the source of a desired sound or scent, travel in search of mating opportunities, etc. To leverage these animalistic responses, various scents, calls, lures, feeders, and other devices are produced each hunting season to increase a likelihood of a successful hunt.

Outside of hunting season, the natural daytime activities of the animals are largely unaffected. However, during hunting season, there is much negative reinforcement and very little positive reinforcement to the various daytime activities. Accordingly, the animals will learn hunting patterns and limit activity to mainly at night, typically well past legal hunting hours.

Conventional animal feeders positively reward the animals in response to the stimuli by providing food. Oftentimes the animals will have access to a product in the animal feeder at all times, both day and night. Since the animals encounter hunting pressure at the conventional feeders during the day, the animals learn to frequent the animal feeder at night when no hunting pressure is present.

Another drawback of continual access to the product in the animal feeder is a large amount of consumption by the animals. Keeping the animal feeder stocked with product becomes time-consuming and expensive.

Accordingly, it is desirable to produce an animal feeder system that limits access to a product contained in the animal feeder system, which improves an efficiency of the animal feeder system, while minimizing cost and effort in manufacturing and maintaining the animal feeder system.

### SUMMARY

In concordance and agreement with the presently described subject matter, an animal feeder system that limits access to a product contained in the animal feeder system, which improves an efficiency of the animal feeder system, while minimizing cost and effort in manufacturing and maintaining the animal feeder system, has surprisingly been discovered.

In one embodiment, the animal feeder system, comprises: a container having a hollow interior configured to receive a product therein; and a closure member coupled to the container, wherein the closure member is selectively positionable between an open first position and a closed second position to control access to the product, wherein the closure member is in the open first position when a first daylight period occurs and/or when an illuminance level of a surrounding environment is at least a predetermined illuminance threshold value, and wherein the closure member is in the closed second position when a second daylight period occurs and/or when the illuminance level of the surrounding environment is less than the predetermined illuminance threshold value.

In another embodiment, an animal feeder system, comprises: a container having a hollow interior configured to receive a product therein; and a closure member coupled to the container, wherein the closure member is selectively positionable between an open first position and a closed second position to control access to the product, wherein the closure member is in the open first position when an illuminance level of a surrounding environment is at least a predetermined illuminance threshold value, and wherein the closure member is in the closed second position when the illuminance level of the surrounding environment is less than the predetermined illuminance threshold value.

In yet another embodiment, a method of controlling an animal feeder system, comprises: providing an animal feeder system comprising a container configured to receive a product therein, wherein the container includes a selectively positionable closure member; and selectively positioning the closure member between an open first position and a closed second position to control access to the product, wherein the closure member is in the open first position when a first daylight period occurs and/or when an illuminance level of a surrounding environment is at least a predetermined illuminance threshold value, and wherein the closure member is in the closed second position when a second daylight period occurs and/or when the illuminance level of the surrounding environment is less than the predetermined illuminance threshold value.

As aspects of some embodiments, the first daylight period occurs from sunrise to sunset and the second daylight period occurs from sunset to sunrise.

As aspects of some embodiments, the first daylight period is from dawn to dusk and the second daylight period is from dusk to dawn.

As aspects of some embodiments, the predetermined illuminance threshold value is in a range of about 0.5 lux to about 25000 lux.

As aspects of some embodiments, the predetermined illuminance threshold value is in a range of about 0.5 lux to about 1000 lux.

As aspects of some embodiments, the predetermined illuminance threshold value is in a range of about 0.5 lux to about 500 lux.

As aspects of some embodiments, the animal feeder system further comprises an actuator assembly coupled to the closure member, wherein the actuator assembly is configured to selectively position the closure member.

As aspects of some embodiments, the animal feeder system further comprises a second sensor configured to sense at least precipitation.

As aspects of some embodiments, the closure member is in the closed second position when the second sensor senses precipitation.

As aspects of some embodiments, the animal feeder system further comprises an electrical system configured to control power to the animal feeder system, wherein the electrical system includes a switch.

As aspects of some embodiments, the switch is in electrical communication with at least one of the first sensor, the second sensor, an actuator system configured to selectively position the closure member, and a power source.

As aspects of some embodiments, the method further comprises an actuator assembly coupled to the closure member, wherein the actuator assembly is configured to selectively position the closure member.

As aspects of some embodiments, at least one of the first sensor and the second sensor is in electrical communication with a switch configured to control the closure member.

### BRIEF DESCRIPTION OF THE DRAWINGS

The accompanying drawings are incorporated herein as part of the specification. The drawings described herein illustrate embodiments of the presently disclosed subject matter, and are illustrative of selected principles and teachings of the present disclosure. However, the drawings do not illustrate all possible implementations of the presently disclosed subject matter, and are not intended to limit the scope of the present disclosure in any way.

FIG. 1 is a side perspective view of an animal feeder system according to an embodiment of the presently disclosed subject matter, wherein a tray and associated closure member are not shown;

FIG. 2 is a front perspective view of the animal feeder system of FIG. 1;

FIG. 3 is a rear left side perspective view of the animal feeder system of FIGS. 1-2;

FIG. 4 is an enlarged front perspective view of a portion of the animal feeder system of FIGS. 1-3;

FIG. 5 is an enlarged perspective view of a portion of an interior of the animal feeder system of FIGS. 1-4, and more particularly showing a portion of an actuator assembly for the animal feeder system in a first position;

FIG. 6 is an enlarged perspective view a portion of the interior of the animal feeder system of FIGS. 1-5, and more particularly showing a portion of the actuator assembly for the animal feeder system in a second position;

FIG. 7 is an enlarged perspective view a portion of the interior of the animal feeder system of FIGS. 1-6 with an electrical system for the actuator assembly for the animal feeder system omitted;

FIG. 8 is a schematic diagram showing the electrical system for the actuator assembly for the animal feeder system of FIGS. 1-7; and

FIG. 9 is a front perspective view of an animal feeder system according to another embodiment of the presently disclosed subject matter, wherein a tray and associated closure member are not shown.

### DETAILED DESCRIPTION

It is to be understood that the presently disclosed subject matter may assume various alternative orientations and step sequences, except where expressly specified to the contrary. It is also to be understood that the specific assemblies and systems illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise. Also, although they may not be, like elements in various embodiments described herein may be commonly referred to with like reference numerals within this section of the application.

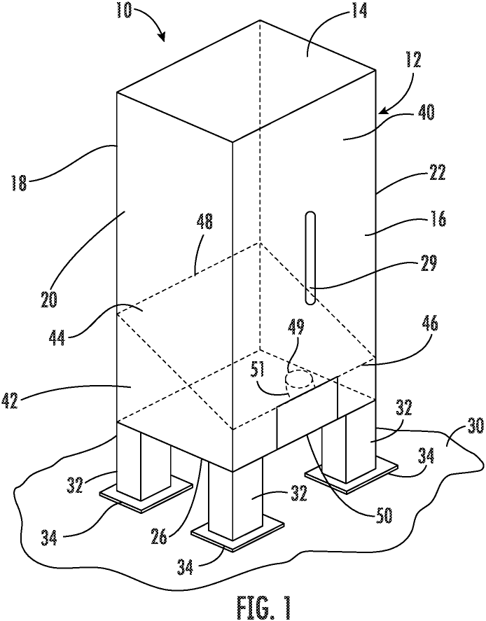

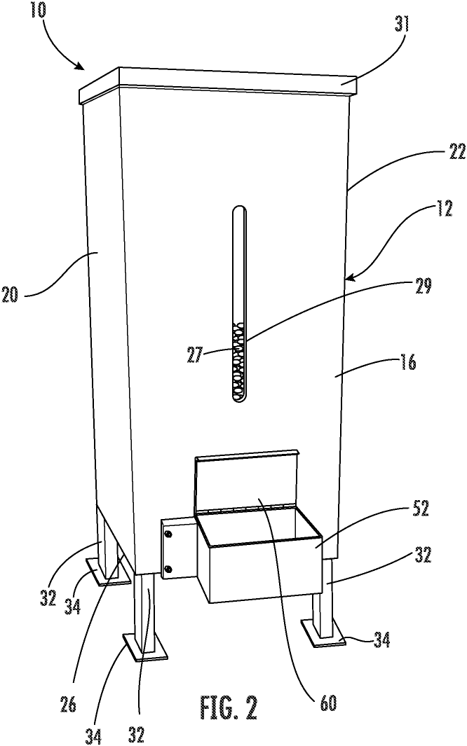

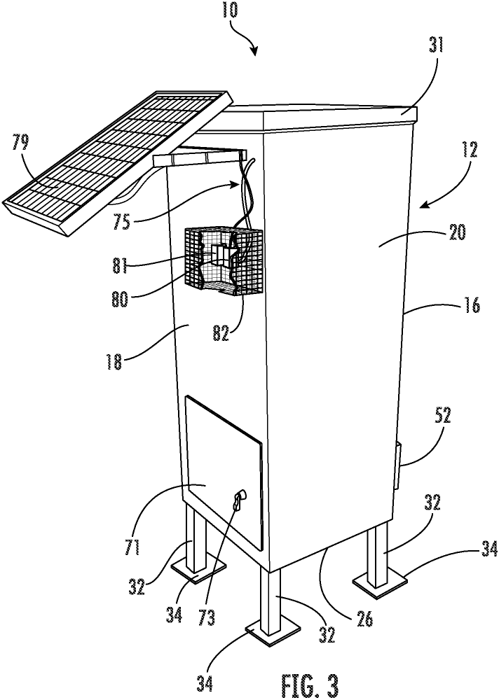

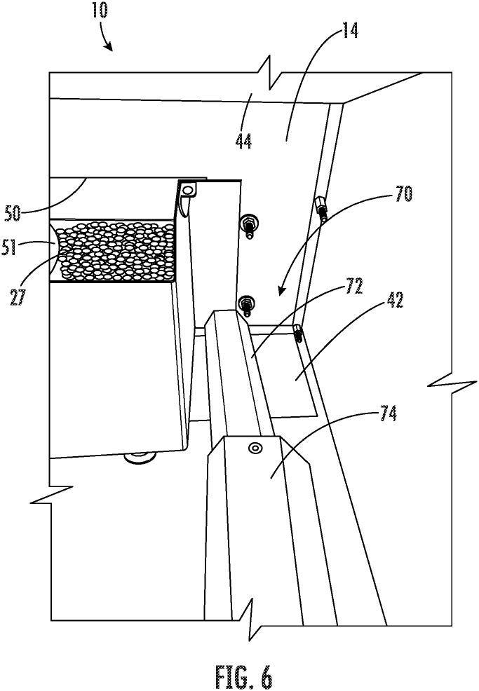

FIGS. 1-7 show an automatic animal feeder system 10 according to an embodiment of the presently described subject matter. The animal feeder system 10 may comprise a container 12. Although the container 12 may be generally rectangular shaped, it is understood that the container 12 may have any suitable shape, size, and configuration as desired. In the embodiment shown, the container 12 may include a hollow interior 14 defined by a front wall 16, a rear wall 18, opposing side walls 20, 22, and a lower wall 26. The interior 14 may be configured to receive a product 27 (depicted in FIGS. 2 and 4-6) such as a feed material and an attractant material for an animal, for example. In a non-limiting example, the product 27 may be a mineral, a grain (e.g. corn, oats, barley), a seed (e.g. sunflower seed), a flavored feed, a kibble, a pellet, a liquid or dry attractant, and the like, or any combination thereof, which is used to feed or attract an animal such as wild game, livestock, birds, pets, and the like, for example. The container 12 shown may hold approximately 30 liquid gallons/ 3.23 bushels/ 4.01 cubic feet of the product 27. It is understood, however, that the container 12 may be have any shape, size, and configuration to hold a desired capacity of the product 27. The container 12 may also include an indicator 29 configured to provide to a user a level of the product 27 within the container 12, and more preferably from great distances. In certain embodiments, the indicator 29 may be a portion of the container 12 formed from a substantially transparent or translucent material. It is understood that the indicator 29 may be any suitable indicator 29 as desired. It is also understood that the indicator 29 may be integrally formed with container 12 or be a separate component coupled to the container 12, if desired.

A cover 31, more clearly shown in FIG. 2, may be removeably disposed on the container 12 to permit a user to fill the container 12 with the product 27. Various materials may be employed to produce the container 12 and the cover 31 such as a metal material, a non-metal material, and combinations thereof. In certain embodiments, the container 12 and the cover 31 are produced from a waterproof material to militate against exposure of the product 27 disposed in the container 12 to outside environmental conditions such as precipitation (e.g. rain, sleet, snow, and the like) that may adversely affect the product 27 or cause spoilage thereof.

The container 12 may be configured to be attached to and/or supported by a mounting structure 30. For example, the container 12 may be configured to be supported underneath by the mounting structure 30 such as the ground as shown in FIG. 1. As another example, the container 12 may also be configured to be supported overhead by the mounting structure 30. In yet another example, the container 12 may be configured to be attached to the mounting structure 30 and supported by one of the walls 16, 18, 20, 22, such as by attachment of the animal feeder system 10 to a vertical mounting structure 30 such a tree, for example.

As illustrated, the container 12 may be supported underneath by a plurality of legs 32. The legs 32 may be located at each corner of the rectangular-shaped container 12. The legs 32 may be selectively positionable and configured to raise the container 12 up and off of a surface of the mounting structure 30 such as a surface of the ground, for example. The legs 32 may be adjusted for varying heights depending on the animal desired by the user to be attracted to the animal feeder system 10. Each of the legs 32 may also include a foot portion 34 for increasing a support area, spreading a weight of the animal feeder system 10 across more surface area, and thereby militating against the legs 32 of the animal feeder system 10 from sinking into the surface of the mounting structure 30. In some embodiments, the legs 32 and/or the foot portions 34 may be configured to affix the container 12 to the mounting structure 30. For example, the foot portion 34 for at least one of the legs 32 may include at least one aperture (not depicted) formed therein for receiving a fastener therethrough, which facilitates affixation of the container 12 to the mounting structure 30.

In certain embodiments, the interior 14 of the container 12 may be separated into a product chamber 40 and a component chamber 42 by a divider 44. The product chamber 40 may be configured to house the product 27 therein and the component chamber 42 may be configured to house at least one component therein. As best seen in FIG. 1, the divider 44 may be disposed within the interior 14 at an angle relative to a plane defined by the surface of the mounting structure 30. The divider 44 may be angled so that a front portion 46 of the divider 44 located adjacent the front wall 16 is generally lower than a rear portion 48 thereof. In some embodiments, the angle of the divider 44 may be such that the product 27 may be caused to flow towards the front wall 16, and at least one egress opening 49 formed in the divider 44, without additional components such as by gravity. As a non-limiting example, the opening 49 has about a 2.5-inch diameter to allow the product 27 to flow from the product chamber 40. The opening 49 may have any suitable size, shape, and configuration as necessary to achieve a desired flow rate of the product 27 from the product chamber 40, essentially the opening 49 may function as a metering component. More or less openings 48 may be formed in the divider 44 as desired. In other embodiments, a mixing mechanism (not depicted) may be disposed in the product chamber 40 to stir the product 27 in order to minimize a growth of mold and other contaminants which would cause the product 27 to spoil. The mixing mechanism may also be configured to facilitate the flow of the product 27 towards the opening 49. As shown, the opening 49 formed in the divider 44 may be in communication with an outlet 50 formed in the container 12, and more preferably formed in the front wall 16 of the container 12. A conduit 51 may be disposed between the opening 49 formed in the divider 44 and the outlet 50. The conduit 51 is configured to permit the flow of the product 27 therethrough. The outlet 50 of the animal feeder system 10 may further include a tray 52 (depicted in FIGS. 2-4) for collecting the product 27 and making it accessible to the animal being attracted. It should be appreciated that the outlet 50 and the tray 52 may have any suitable shape, size, and configuration as desired. A guard (not depicted) may be disposed adjacent at least one of the outlet 50 and the tray 52 to militate against exposure of the product 27 disposed in the container 12 to outside environmental conditions such as precipitation (e.g. rain, sleet, snow, and the like) that may adversely affect the product 27 or cause spoilage thereof.

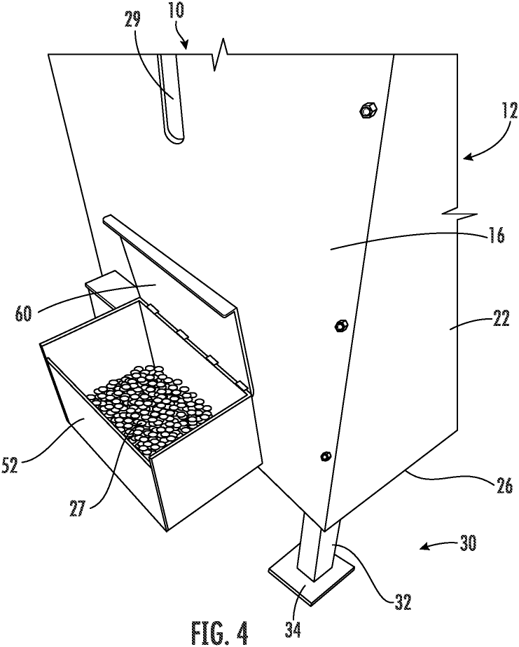

A closure member 60 may be moveably coupled to the container 12 to control access to the product 27 located within at least one of the product chamber 40 and the tray 52. In certain embodiments, the closure member 60 is selectively positionable between a fully open first position (depicted in FIGS. 2 and 4), a fully closed second position, and intermediate positions therebetween. When the closure member 60 is in the fully open first position, the flow of the product 27 from the product chamber 40 through the opening 49, the conduit 51, and/or the outlet 50 is unrestricted and the product 27 is fully accessible to the animal. On the contrary, when the closure member 60 is in the fully closed second position, the flow of the product 27 from the product chamber 40 may be completely restricted and the product 27 is inaccessible to the animal. When the closure member 60 is in the intermediate positions between the first and second positions, the flow of the product 27 from the product chamber 40 may be slightly restricted, yet the product 27 is still accessible to the animal. As a non-limiting example, the closure member 60 may be a hinged or sliding door coupled to the outlet 50, and in particular embodiments, coupled to the tray 52. A heating element (not depicted) may be employed with the closure member 60 to provide heating thereto to militate against an accumulation of precipitation (e.g. snow and ice) on the closure measure 60. The closure member 60 may also be coupled to an actuator assembly 70 of the animal feeder assembly 10.

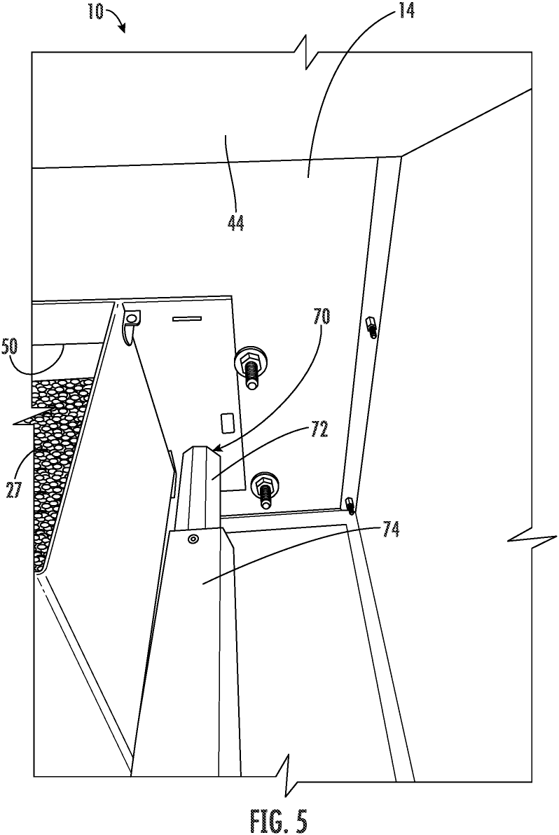

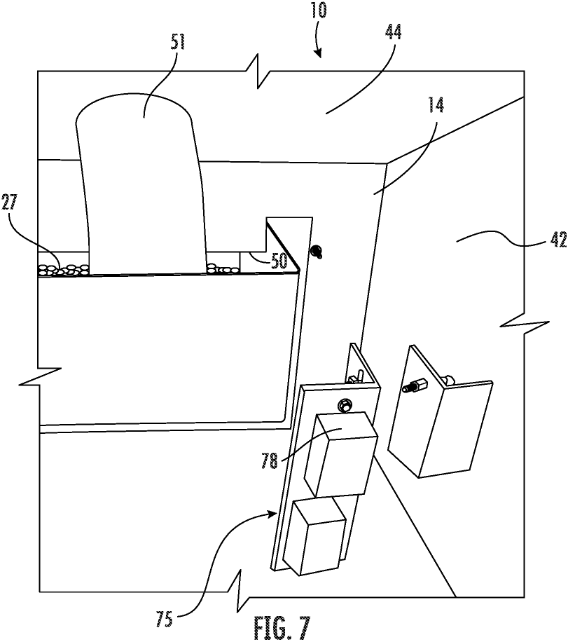

As more clearly shown in FIGS. 5 and 7, the actuator assembly 70 may be disposed in the component chamber 42 of the container 12. The component chamber 42 may be accessible to the user of the animal feeder system 10 via a panel 71. The panel 71 may include a lock 73 to militate against undesired entry into the component chamber 42 of the container 12.

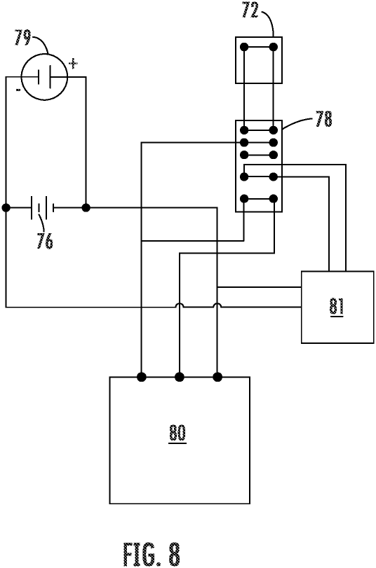

In certain embodiments, the actuator assembly 70 may include an actuator 72 and a drive component 74 (e.g. a motor) drivingly coupled to the actuator 72. An electrical system 75 of the animal feeder system 10 may include a power source 76 (e.g. a rechargeable battery) in electrical communication with one or more components of the actuator assembly 70. For example, the power source 76 may be in electrical communication with the drive component 74. At least one of the actuator 72, the drive component 74, and the power source 76 is disposed within the component chamber 42 of the container 12 to militate against exposure thereof to environmental conditions that may cause damage thereto. The actuator 72, driven by the drive component 74, is configured to selectively position the closure member 60 between the first and second positions. The power source 76 is configured to supply power to the drive component 74. In a preferred embodiment shown in FIG. 8, the power source 76 supplies the power to the drive component 74 through a switch 78 (e.g. a reverse polarity relay switch) of the electrical system 75.

The electrical system 75 may further include a first sensor 80 (e.g. a light/time sensor, a dusk to dawn sensor, a day/night sensor, a photo-electric sensor, a photo call, etc.) configured to sense at least one of an illuminance level of a surrounding environment and a time period. The first sensor 80 may also be in electrical communication with the actuator assembly 70 and/or the power source 76. In some embodiments shown in FIG. 8, the first sensor 80 may be in electrical communication with the drive component 74 through a switch (e.g., the switch 78). It is understood that other suitable sensors may be employed as the first sensor 80 if desired. The first sensor 80 may be configured to control access to the product 27. In a preferred embodiment, the first sensor 80 is configured to cause the actuator assembly 70 to selectively position the closure member 60 in the open first position when a first daylight period occurs (e.g., daytime, sunrise to sunset, dawn to dusk), and/or during a first predetermined time period (e.g. daytime hours, 6 a.m. to 6 p.m., etc.), and/or when the illuminance level of the surrounding environment is at least a predetermined illuminance threshold value. In some embodiments, the predetermined illuminance threshold value may be in a range of about 0.5 lux to about 25000 lux, preferably in a range of about 0.5 lux to about 1000 lux, and most preferably in a range of about 0.5 lux to about 500 lux. As a non-limiting example, the predetermined illuminance threshold value may be 1 lux, and therefore, the closure member 60 is positioned in the open first position when the illuminance level of the surrounding environment is 1 lux or more.

Additionally, the first sensor 80 is configured to cause the actuator assembly 70 to selectively position the closure member 60 in the closed second position when a second daylight period occurs (e.g., nighttime, sunset to sunrise, dusk to dawn), and/or during a second predetermined time period (e.g. nighttime hours, 6 p.m. to 6 a.m., etc.), and or when the illuminance level of the surrounding environment is less than the predetermined illuminance threshold value. For example, the closure member 60 may be positioned in the closed second position when the illuminance level of the surrounding environment is less than 1 lux.

The electrical system 75 may further include a generator 79 (e.g., a solar panel) coupled to the power source 76, as depicted in FIG. 8. The generator 79 is configured to collect and convert solar rays from the sun to generate electrical power which is then used to charge the power source 76.

In some embodiments, the electrical system 75 of the animal feeder system 10 may further include a second sensor 81. The second sensor 81 may also be in electrical communication with the actuator assembly 70 and/or the power source 76. The second sensor 81 may be configured to sense at least one environmental condition outside of the animal feeder system 10. In certain embodiments, the second sensor 81 is configured to sense precipitation such as rain, sleet, snow, and the like, for example, that may adversely affect the product 27 or cause spoilage thereof. The second sensor 81, as shown in FIG. 8, may also be in electrical communication with the drive component 74 through the switch 78. It is understood that other suitable sensors may be employed as the second sensor 81 if desired. The second sensor 80 may be configured to control access to the product 27. In a preferred embodiment, the second sensor 81 is configured to cause the actuator 72 to selectively position the closure member 60 in the closed second position during periods of precipitation.

In embodiments of the animal feeder system 10 that employ both of the sensors 80, 81, it is understood that during periods of relatively no precipitation, the first sensor 80 controls the actuator assembly 70 to selectively position the closure member 60 as described hereinabove for the respective daylight periods, the illuminance levels of the surrounding environment, and/or the predetermined time periods. However, during periods of relative precipitation that occur during the first daylight period, when the illuminance level of the surrounding environment is at least the predetermined illuminance threshold value, and/or during the first predetermined time period, the second sensor 81 overrides the first sensor 80 and causes the actuator assembly 70 to selectively position the closure member 60 in the closed second position. Accordingly, the product 27 in the tray 52 may be protected from the precipitation by the closure member 60.

It is also understood that each of the sensors 80, 81 may be positioned elsewhere on the animal feeder system 10 than as depicted. A protective device (e.g., a cage) may be disposed around at least one of the sensors 80, 81 to provide protection thereto.

In other embodiments, the electrical system 75 of the animal feeder system 10 may further include a controller (not depicted). The controller may be in wire and/or wireless communication with at least one of the indicator 29, the actuator assembly 70, the first sensor 80, and/or the second sensor 81. The controller may be configured to receive signals from and transmit signals to at least one of the indicator 29, the actuator assembly 70, and/or the sensors 80, 81. In some embodiments, the controller may receive a signal from the indicator 29 indicative of the level of the product 27 within the product chamber 40. In other embodiments, the controller may receive a signal from the actuator assembly 70 indicative of a position of the closure member 60. The controller may also be configured to control the actuator assembly 70, and thereby control access to the product 27. More preferably, the controller may be configured to cause the actuator 72 to selectively position the closure member 60 in the open first position when a first daylight period occurs (e.g., daytime, sunrise to sunset, dawn to dusk), and/or during a first predetermined time period (e.g. daytime hours, 6 a.m. to 6 p.m., etc.), and/or when the illuminance level of the surrounding environment is at least a predetermined illuminance threshold value. In some embodiments, the predetermined illuminance threshold value may be in a range of about 0.5 lux to about 25000 lux, preferably in a range of about 0.5 lux to about 1000 lux, and most preferably in a range of about 0.5 lux to about 500 lux. As a non-limiting example, the predetermined illuminance threshold value may be 1 lux, and therefore, the closure member 60 is positioned in the open first position when the illuminance level of the surrounding environment is 1 lux or more.

Additionally, the controller may be configured to cause the actuator assembly 70 to selectively position the closure member 60 in the closed second position when a second daylight period occurs (e.g., nighttime, sunset to sunrise, dusk to dawn), and/or during a second predetermined time period (e.g. nighttime hours, 6 p.m. to 6 a.m., etc.), and/or when the illuminance level of the surrounding environment is less than the predetermined illuminance threshold value. For example, the closure member 60 may be positioned in the closed second position when the illuminance level of the surrounding environment is less than 1 lux.

In some embodiments, the controller may be in communication with a remote electronic device (i.e. a smartphone) that may be employed by the user to receive notifications (e.g. product level, power level, interrupted operation, malfunctions, and other component statuses, etc.) from and transmit control signals to the controller for controlling an operation of the animal feeder system 10. For example, the user may utilize the electronic device to remotely activate the actuator assembly 70 to cause the closure member 60 to move between the fully open first position, the fully closed second position, and the intermediate positions therebetween (i.e. such as to cause the closure member 60 to move to the fully closed second position when it is raining outside).

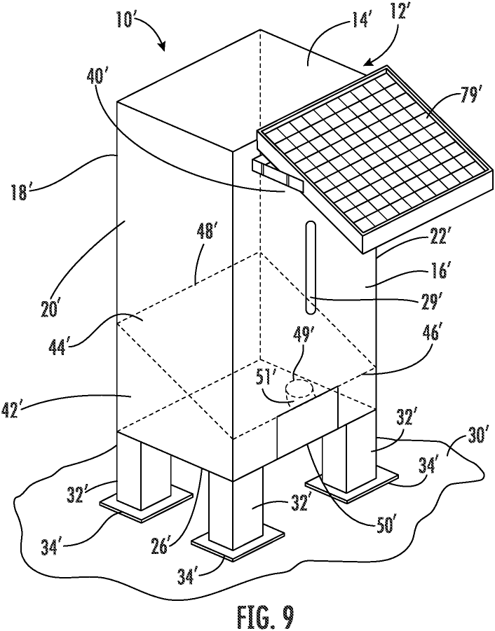

FIG. 9 shows an animal feeder system 10′ according to another embodiment of the present disclosure. Reference numerals for similar structure in respect of the description of FIGS. 1-8 are repeated in FIG. 9 with a prime (′) symbol. Structure of the animal feeder system 10′ is substantially similar to that of the animal feeder system 10, except a power source 79′ is located on a front wall 16′ thereof instead of a rear wall 18′. Advantages of such location of the power source 79′ is that it provides further protection of a product 27′ within a tray 52′ and permits the animal feeder system 10′ to be attached to a mounting structure via the rear wall 18′.

While various embodiments have been described above, it should be understood that they have been presented by way of example, and not limitation. It will be apparent to persons skilled in the relevant arts that the disclosed subject matter may be embodied in other specific forms without departing from the spirit or essential characteristics thereof. The embodiments described above are therefore to be considered in all respects as illustrative, not restrictive.

What is claimed is:

1. An animal feeder system, comprising:
a container having a hollow interior configured to receive a product therein; and
a closure member coupled to the container, wherein the closure member is selectively positionable between an open first position and a closed second position to control access to the product, wherein the closure member is in the open first position when a first daylight period occurs and/or when an illuminance level of a surrounding environment is at least a predetermined illuminance threshold value, and wherein the closure member is in the closed second position when a second daylight period occurs and/or when the illuminance level of the surrounding environment is less than the predetermined illuminance threshold value.

2. The animal feeder system of claim 1, wherein the first daylight period occurs from sunrise to sunset and the second daylight period occurs from sunset to sunrise.

3. The animal feeder system of claim 1, wherein the first daylight period is from dawn to dusk and the second daylight period is from dusk to dawn.

4. The animal feeder system of claim 1 wherein the predetermined illuminance threshold value is in a range of about 0.5 lux to about 25000 lux.

5. The animal feeder system of claim 1, wherein the predetermined illuminance threshold value is in a range of about 0.5 lux to about 1000 lux.

6. The animal feeder system of claim 1, wherein the predetermined illuminance threshold value is in a range of about 0.5 lux to about 500 lux.

7. The animal feeder system of claim 1, further comprising an actuator assembly coupled to the closure member, wherein the actuator assembly is configured to selectively position the closure member.

8. The animal feeder system of claim 1, further comprising a second sensor configured to sense at least precipitation.

9. The animal feeder system of claim 8, wherein the closure member is in the closed second position when the second sensor senses precipitation.

10. The animal feeder system of claim 1, further comprising an electrical system configured to control power to the animal feeder system, wherein the electrical system includes a switch.

11. The animal feeder system of claim 10, wherein the switch is in electrical communication with at least one of the first sensor, the second sensor, an actuator system configured to selectively position the closure member, and a power source.

12. An animal feeder system, comprising:
a container having a hollow interior configured to receive a product therein; and
a closure member coupled to the container, wherein the closure member is selectively positionable between an open first position and a closed second position to control access to the product, wherein the closure member is in the open first position when an illuminance level of a surrounding environment is at least a predetermined illuminance threshold value, and wherein the closure member is in the closed second position when the illuminance level of the surrounding environment is less than the predetermined illuminance threshold value.

13. A method of controlling an animal feeder system, comprising:
providing an animal feeder system comprising a container configured to receive a product therein, wherein the container includes a selectively positionable closure member; and
selectively positioning the closure member between an open first position and a closed second position to control access to the product, wherein the closure member is in the open first position when a first daylight period occurs and/or when an illuminance level of a surrounding environment is at least a predetermined illuminance threshold value, and wherein the closure member is in the closed second position when a second daylight period occurs and/or when the illuminance level of the surrounding environment is less than the predetermined illuminance threshold value.

14. The method of claim 13, wherein the first daylight period occurs from sunrise to sunset and the second daylight period occurs from sunset to sunrise.

15. The method of claim 13, wherein the first daylight period is from dawn to dusk and the second daylight period is from dusk to dawn.

16. The method of claim 13, wherein the predetermined illuminance threshold value is in a range of about 0.5 lux to about 500 lux.

17. The method of claim 13, further comprising an actuator assembly coupled to the closure member, wherein the actuator assembly is configured to selectively position the closure member.

18. The method of claim 13, further comprising a second sensor configured to sense at least precipitation.

19. The method of claim 18, wherein the closure member is in the closed second position when the second sensor senses precipitation.

20. The method of claim 18, wherein at least one of the first sensor and the second sensor is in electrical communication with a switch configured to control the closure member.
